(19) United States
(12) Patent Application Publication
(10) Pub. No.: US 2026/0339029 A1
(43) Pub. Date: Oct. 29, 2026

(54) OPTICAL COMBINER FOR DISTRIBUTING LASER LIGHT/POWER TO A MULTI-CORE OUTPUT FIBER AND LASER SYSTEM INCORPORATING THE OPTICAL COMBINER

(71) Applicant: nLIGHT, Inc., Camas, WA (US)

(72) Inventors: Teemu Kokki, Vancouver, WA (US); Juan Carlos Lugo, Vancouver, WA (US); Mathieu Antoina, Vancouver, WA (US); Katrina Lane, Portland, OR (US); Roger Farrow, Vancouver, WA (US); Dahv A.V. Kliner, Portland, OR (US)

(21) Appl. No.: 19/115,178

(22) PCT Filed: Sep. 25, 2023
(86) PCT No.: PCT/US2023/033604

§ 371 Date: Mar. 25, 2025

Related U.S. Application Data
(60) Provisional application No. 63/410,370, filed on Sep. 27, 2022.

(51) Int. Cl. G02B 6/28; G02B 6/02; G02B 6/26

(52) U.S. Cl. CPC G02B 6/2804; G02B 6/02042; G02B 6/262

(57) ABSTRACT

An optical combiner includes a fiber bundle with a plurality of input fibers, an output fiber with an inner core surrounded by an outer core, a splice fusing the fiber bundle to the output fiber, at least a first input fiber from the plurality of input fibers being aligned in register with the inner core, and at least a second input fiber from the plurality of input fibers being aligned in register with the outer core. A laser system combines the optical combiner with a plurality of lasers generating laser light.

### CROSS-REFERENCE TO RELATED APPLICATION(S)

This United States Non-Provisional Patent Application is a National Stage Entry that relies on and claims priority to International Patent Application No. PCT/US2023/033604, filed on Sep. 25, 2023, and also relies on and claims priority to U.S. Provisional Patent Application No. 63/410,370, filed on Sep. 27, 2022, the entire contents of both which are hereby incorporated by reference in their entireties.

### FIELD OF THE INVENTION

The present invention concerns a construction for an optical combiner used to distribute laser light/power to a multi-core output fiber. More specifically, the present invention is contemplated to encompass, in at least one embodiment, a construction for an optical combiner that distributes laser light/power between inner and outer cores in a multi-core output fiber. The present invention also encompasses a laser system incorporating the optical combiner.

### DESCRIPTION OF THE RELATED ART

As should be apparent to those skilled in the art, it is commonplace to connect one or more lasers with an output fiber so that laser light generated by the laser(s) may be directed, via the output fiber, to a target area.

To do this, the prior art offers a number of solutions.

Some of those solutions involve lenses and optical focusing devices that couple a laser to the output fiber and that concentrate/direct the laser light into the output fiber.

Other solutions involve only fiber components.

### SUMMARY OF THE INVENTION

Among other objectives, the present invention seeks to provide a construction for an optical combiner that connects two or more lasers, via a fiber bundle, to a multi-core output fiber in a simple, reliable manner.

It is, therefore, an aspect of the present invention to provide an optical combiner that includes a fiber bundle with a plurality of input fibers and an output fiber with an inner core surrounded by an outer core. The fiber bundle is fusion spliced to the output fiber. At least a first input fiber from the plurality of input fibers is aligned in register with the inner core. At least a second input fiber from the plurality of input fibers is aligned in register with the outer core.

In one contemplated embodiment of the optical combiner, at least one of the plurality of input fibers comprises multiple claddings.

In another contemplated embodiment of the optical combiner, the output fiber comprises multiple claddings.

In another embodiment, the optical combiner may be configured such that the plurality of input fibers encompasses the first input fiber, the second input fiber, a third input fiber, a fourth input fiber, a fifth input fiber, a sixth input fiber, and a seventh input fiber.

In this configuration, the first input fiber is contemplated to be surrounded by the second input fiber, the third input fiber, the fourth input fiber, the fifth input fiber, the sixth input fiber, and the seventh input fiber.

Here, the third input fiber, the fourth input fiber, the fifth input fiber, the sixth input fiber, and the seventh input fiber are aligned in register with the outer core.

In another contemplated embodiment, the plurality of input fibers includes the first input fiber, the second input fiber, and a third input fiber.

Here, the first input fiber is disposed adjacent to the second input fiber and the third input fiber in a linear configuration.

In this configuration, the second input fiber and the third input fiber are contemplated to be aligned in register with the outer core.

In yet another contemplated configuration of the optical combiner of the present invention, the first input fiber is disposed adjacent to the second input fiber and the third input fiber in a triangular configuration.

In this configuration, the third input fiber also is aligned in register with the outer core.

It is contemplated that the optical combiner of the present invention may incorporate a glass support structure, where the plurality of input fibers is disposed in the glass support structure.

It is also contemplated that that the optical combiner may be configured so that the output fiber includes a first output fiber segment fused to a second output fiber segment at a second splice.

If so, the second splice may be a multi-core step-up splice.

The present invention also is contemplated to encompass a laser system that combines a plurality of lasers generating laser light and an optical combiner connected to the plurality of lasers. The optical combiner includes a fiber bundle with a plurality of input fibers receiving the laser light from the plurality of lasers, an output fiber with an inner core surrounded by an outer core receiving the laser light from the fiber bundle, a splice fusing the fiber bundle to the output fiber, at least a first input fiber from the plurality of input fibers being aligned in register with the inner core, and at least a second input fiber from the plurality of input fibers being aligned in register with the outer core.

In one contemplated embodiment of the laser system, at least one of the plurality of input fibers comprises multiple claddings.

In another contemplated embodiment of the laser system, the output fiber comprises multiple claddings.

In a contemplated embodiment, the laser system may be constructed so that the plurality of input fibers comprises the first input fiber, the second input fiber, a third input fiber, a fourth input fiber, a fifth input fiber, a sixth input fiber, and a seventh input fiber, a first laser from the plurality of lasers provides light to the first input fiber, and at least a second laser from the plurality of lasers provides light to at least the second input fiber.

Here, the first input fiber may be surrounded by the second input fiber, the third input fiber, the fourth input fiber, the fifth input fiber, the sixth input fiber, and the seventh input fiber.

It is contemplated that the laser system may be configured so that the third input fiber, the fourth input fiber, the fifth input fiber, the sixth input fiber, and the seventh input fiber also are aligned in register with the outer core.

In another contemplated configuration of the laser system, the plurality of input fibers encompasses the first input fiber, the second input fiber, and a third input fiber, a first laser from the plurality of lasers provides light to the first input fiber, and at least a second laser from the plurality of lasers provides light to at least the second input fiber.

Here, the first input fiber is disposed adjacent to the second input fiber and the third input fiber in a linear configuration. If so, the third input fiber is contemplated to be aligned in register with the outer core.

In another configuration, the laser system is structured so that the first input fiber is disposed adjacent to the second input fiber and the third input fiber in a triangular configuration. If so, the third input fiber also is contemplated to be aligned in register with the outer core.

The laser system also may be configured to include a glass support structure with the plurality of input fibers is disposed therein.

Still further, the laser system may include an output fiber where a first output fiber segment is fused to a second output fiber segment at a second splice. This second splice may be a multi-core step-up splice.

Still further advantages and features of the present invention will be made apparent by the discussion presented hereinbelow.

### BRIEF DESCRIPTION OF THE DRAWINGS

The present invention will now be described in connection with the drawings appended hereto, in which:

FIG. 1 is a graphical, side view of a first embodiment of a laser system incorporating one contemplated embodiment of an optical combiner of the present invention;

FIG. 2 presents a graphical, cross-sectional view of a first embodiment of an input fiber bundle and a graphical, cross-sectional view of one contemplated embodiment of an output fiber, where the input fiber bundle and the output fiber are contemplated to be fused to one another in the optical combiner of the present invention;

FIG. 3 is a combined, graphical, cross-sectional view of the first embodiment of the input fiber bundle and the output fiber shown in FIG. 2, illustrating one way in which the first embodiment of the input fiber bundle is contemplated to register with the output fiber when the two are fused to one another;

FIG. 4 presents a graphical, cross-sectional view of a second embodiment of an input fiber bundle and the graphical, cross-sectional view of the output fiber shown in FIG. 2, where the input fiber bundle and the output fiber are contemplated to be fused to one another in the optical combiner of the present invention;

FIG. 5 is a combined, graphical, cross-sectional view of the second embodiment of the input fiber bundle and the output fiber shown in FIG. 2, illustrating one way in which the second embodiment of the input fiber bundle is contemplated to register with the output fiber when the two are fused to one another;

FIG. 6 presents a graphical, cross-sectional view of a third embodiment of an input fiber bundle and the graphical, cross-sectional view of the output fiber shown in FIG. 2, where the input fiber bundle and the output fiber are contemplated to be fused to one another in the optical combiner of the present invention;

FIG. 7 is a combined, graphical, cross-sectional view of the third embodiment of the input fiber bundle and the output fiber shown in FIG. 2, illustrating one way in which the third embodiment of the input fiber bundle is contemplated to register with the output fiber when the two are fused to one another;

FIG. 8 presents a graphical, cross-sectional view of a fourth embodiment of an input fiber bundle and the graphical, cross-sectional view of the output fiber shown in FIG. 2, where the input fiber bundle and the output fiber are contemplated to be fused to one another in the optical combiner of the present invention;

FIG. 9 is a combined, graphical, cross-sectional view of the fourth embodiment of the input fiber bundle and the output fiber shown in FIG. 2, illustrating one way in which the fourth embodiment of the input fiber bundle is contemplated to register with the output fiber when the two are fused to one another;

FIG. 10 is a graphical, side view of a second contemplated embodiment of a laser system of the present invention, illustrating a contemplated variation on the construction of the output fiber;

FIG. 11 is a graphical, cross-sectional view of a fifth embodiment of the input fiber bundle, which is contemplated as a variation of the first embodiment of the input fiber bundle illustrated in FIG. 3;

FIG. 12 is a graphical, cross-sectional side view of a multi-core step-up splice of the type that may be employed with the present invention; and

FIG. 13 is a cross-sectional graphical illustration of an optic fiber with multiple claddings.

### BRIEF DESCRIPTION OF EMBODIMENT(S) OF THE INVENTION

The present invention will now be described in connection with one or more embodiments. Where possible, the same reference numbers are employed to refer to like structures and/or features. Unless otherwise indicated, the use of the same reference numbers should not be understood to mean that each structure using the same reference number is identical to each other structure using that reference number. To the contrary, as should be apparent to those skilled in the art, variations and equivalents of the structures may be employed. Those variations and equivalents are contemplated to be encompassed by the present invention, even if not explicitly discussed herein.

The present invention also will be described in connection with one or more materials. Any materials described herein are intended to be exemplary of the possible materials that may be employed and are not intended to limit the scope of the present invention. Moreover, any discussion about specific characteristics and parameters of any material should not be understood to be limiting of the material, unless otherwise stated.

The various illustrations of the present invention are not drawn to scale unless specifically indicated. As a result, any suitable dimensions are intended to be encompassed by the drawings.

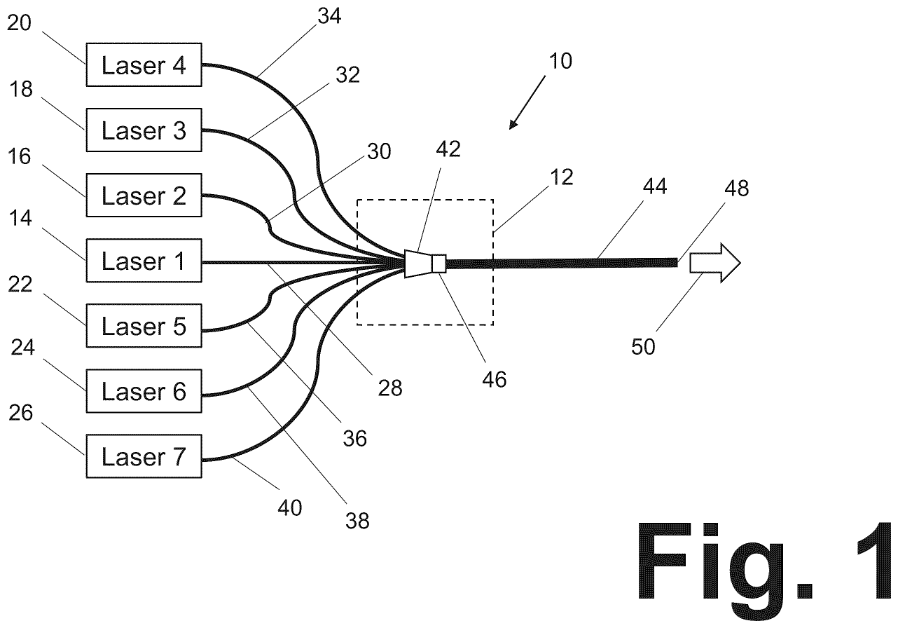

FIG. 1 is a graphical, side view of a laser system 10 according to the teachings of the present invention. The laser system 10 incorporates one contemplated embodiment of an optical combiner 12 according to the present invention.

In the illustrated embodiment, the laser system 10 includes seven lasers 14, 16, 18, 20, 22, 24, 26 connected to seven input fibers 28, 30, 32, 34, 36, 38, 40.

While seven lasers 14, 16, 18, 20, 22, 24, 26 are illustrated, it is contemplated that the laser system 10 may employ any number of lasers greater than or equal to two. Accordingly, in several contemplated embodiments, the laser system 10 may employ two, three, four, five, six, seven lasers, or more without departing from the scope of the present invention.

Similarly, while seven input fibers 28, 30, 32, 34, 36, 38, 40 are illustrated, it is contemplated that the laser system 10 may employ any number of input fibers greater than or equal to two. Accordingly, the laser system 10 may employ two, three, four, five, six, seven, or more input fibers without departing from the scope of the present invention.

It is noted that there is no upper limit, theoretically, to the number of lasers and to the number of input fibers that may be employed by/for the present invention. However, practical considerations suggest that the maximum may be around nineteen lasers and nineteen input fibers. Therefore, in still other embodiments, it is contemplated that the laser system 10 may encompass eight, nine, ten, eleven, twelve, thirteen, fourteen, fifteen, sixteen, seventeen, eighteen, or nineteen lasers and/or input fibers.

In the illustrated embodiments, one laser is associated with one input fiber. It is noted that this correlation is merely illustrative of one contemplated arrangement of lasers and input fibers. In alternative arrangements and configurations, for example, multiple lasers may be connected to a single input fiber without departing from the scope of the present invention. Similarly, multiple input fibers may be connected to a single laser. Still further, it is contemplated that one or more input fibers may not be connected to a laser at all.

At a minimum, the laser system 10 of the present invention is contemplated to require two lasers and two input fibers. However, the actual number may be selected, as required or as desired, for a particular installation and/or application, as should be apparent to those skilled in the art.

In the embodiment illustrated in FIG. 1, the lasers 14, 16, 18, 20, 22, 24, 26 may be of any type. They may generate light differing in intensity from one another. They may also generate light with wavelengths that differ from one another.

In one non-limiting example, each of the lasers 14, 16, 18, 20, 22, 24, 26 may generate light with the same power.

In one non-limiting example, each of the lasers 14, 16, 18, 20, 22, 24, 26 may generate light with the same wavelength. In other non-limiting examples, the lasers 14, 16, 18, 30, 22, 24 may generate light with wavelengths differing from one another.

While not intended to be limiting of the present invention, by way of example only, it is suggested that each of the lasers 14, 16, 18, 20, 22, 24, 26 may be 1 kW lasers, meaning that each laser generates 1 kW of output light. In other non-limiting examples, one or more of the lasers 14, 16, 18, 20, 22, 24, 26 may be ≤1 kW, 1 kW, 2 kW, 3 kW, 4 kW, 5 kW, 6 kW, and/or ≥6 kW lasers, or other power levels. The lasers 14, 16, 18, 20, 22, 24, 26 do not need to generate the same power to remain within the scope of the present invention.

As should be apparent to those skilled in the art, the lasers 14, 16, 18, 20, 22, 24, 26 may have any wavelength and any output intensity/power as may be desired and/or required for a particular application. In other words, as should be apparent from the foregoing, non-limiting examples, the scope of the present invention is not limited to any particular laser power and/or wavelength. Still further, one or more of the lasers 14, 16, 18, 20, 22, 24, 26 may be a single-mode or a multimode laser without departing from the scope of the present invention.

It is also contemplated that one or more of the lasers 14, 16, 18, 20, 22, 24, 26 may be controllable so that, for example, the output power may be adjusted during operation. One or more of the lasers 14, 16, 18, 20, 22, 24, 26 also may be adjustable in other ways without departing from the scope of the present invention.

As shown in FIG. 1, the input fibers 28, 30, 32, 34, 36, 38, 40 extend from the lasers 14, 16, 18, 20, 22, 24, 26 to a fiber bundle 42. The input fibers 28, 30, 32, 34, 36, 38, 40 are contemplated to be made primarily of fused silica, with suitable dopants known to those skilled in the art. These dopants are typically used to raise or lower the index of refraction.

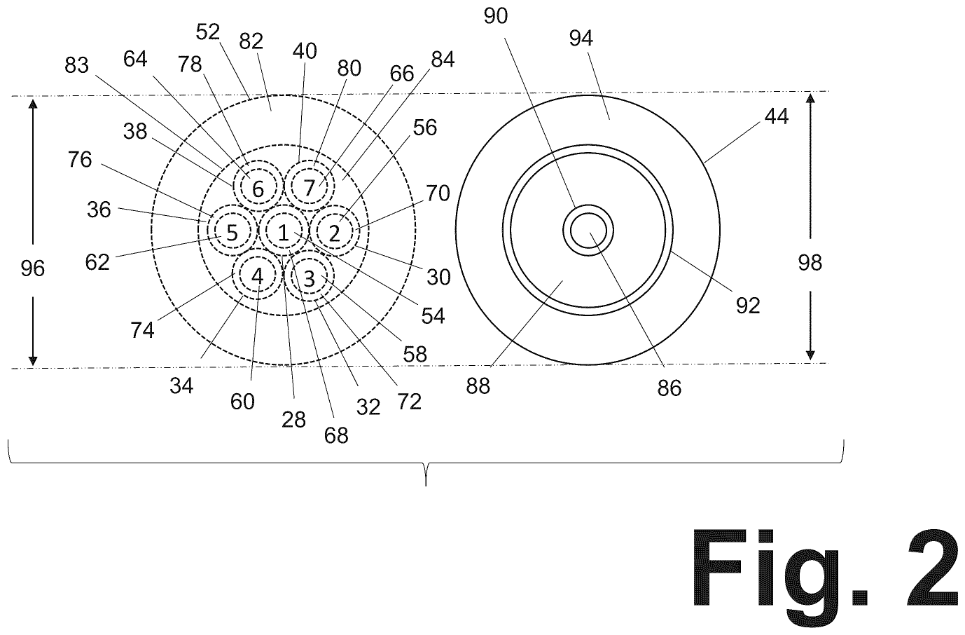

Details of the fiber bundle 42 will be described in connection with the embodiments illustrated in FIGS. 2-9.

It is noted that, while the fiber bundle 42 is shown as a separate structure, the fiber bundle is not contemplated to be a structure and/or component that is separate from the input fibers 28, 30, 32, 34, 36, 38, 40. To the contrary, the designation of the fiber bundle 42 is intended to illustrate a structure where the input fibers 28, 30, 32, 34, 36, 38, 40 are combined together so that the laser light from the lasers 14, 16, 18, 20, 22, 24, 26 may be introduced and/or inputted into an output fiber 44. The fiber bundle 42 may be a structure where the input fibers 28, 30, 32, 34, 36, 38, 40 are fused together, for example, into a unitary component.

Like the input fibers 28, 30, 32, 34, 36, 38, 40, the output fiber 44 is contemplated to be made primarily of fused silica, with suitable dopants known to those skilled in the art.

The fiber bundle 42 connects to the output fiber 44 via a first splice 46. The details of a splice are not provided here, because splicing is well known to those skilled in the art. The first splice 46 is an optical and a physical connection between the fiber bundle 42 and the output fiber 44 that permits light from the lasers 14, 16, 18, 20, 22, 24, 26 to be transmitted from the input fibers 28, 30, 32, 34, 36, 38, 40 to the output fiber 44. Without limiting the meaning of the term “splice,” as would be understood by those skilled in the art, the splice 46 fuses the fiber bundle 42 to the output fiber 44 in a monolithic structure with no free-space beams.

The light travelling through the output fiber 44 exits from the output fiber at a distal end 48. The exiting light is indicated by the arrow 50 and is referred to herein as the output light 50.

With further reference to FIG. 1, it is noted that the optical combiner 12 of the present invention encompasses the output ends of the input fibers 28, 30, 32, 34, 36, 38, 40, the fiber bundle 42, the input end of the output fiber 44, the first splice 46, and a length of output fiber 44. The dotted-line box delineates the optical combiner 12.

It is noted that the designation of these enumerated structures within the dotted-line box for the optical combiner 12 is not intended to be limiting of the present invention. Variations and substitutions may be made, as should be apparent to those skilled in the art, without departing from the scope of the present invention.

FIG. 2 presents a graphical, cross-sectional view of a first embodiment of an input fiber bundle, referred to herein as the first input fiber bundle 52, which is shown on the left side of the drawing. FIG. 2 also provides a graphical, cross-sectional view of one contemplated embodiment of the output fiber 44. As indicated above, the first fiber bundle 52 is contemplated to connect to the output fiber 44 at the first splice 46 illustrated in FIG. 1.

Throughout FIGS. 2-9, the graphical, cross-sectional view of the output fiber 44 is the same. This convention has been adopted purposefully to simplify the discussion of the present invention.

The output fiber 44 is depicted as being a two-core optic fiber, meaning that the optic fiber 44 includes an inner core 86 surrounded by an outer, ring-shaped core 88, as discussed in greater detail in the paragraphs that follow. For this reason, the output fiber 44 also is referred to as a multi-core output fiber 44 herein.

Despite illustrating the output fiber 44 uniformly throughout the drawings, it is noted that the structure of the output fiber 44 may be changed from the embodiment depicted without departing from the scope of the present invention. For example, the output fiber 44 may be constructed as a two-ring (triple-core) structure, which would be suitable if the input fiber bundle 42 combined nineteen separate input fibers together in a 1:6:12 arrangement (one fiber, surrounded by six fibers, surrounded by twelve fibers). Still other constructions for the output fiber 44 and corresponding input bundle 42 may be employed, as should be apparent to those skilled in the art.

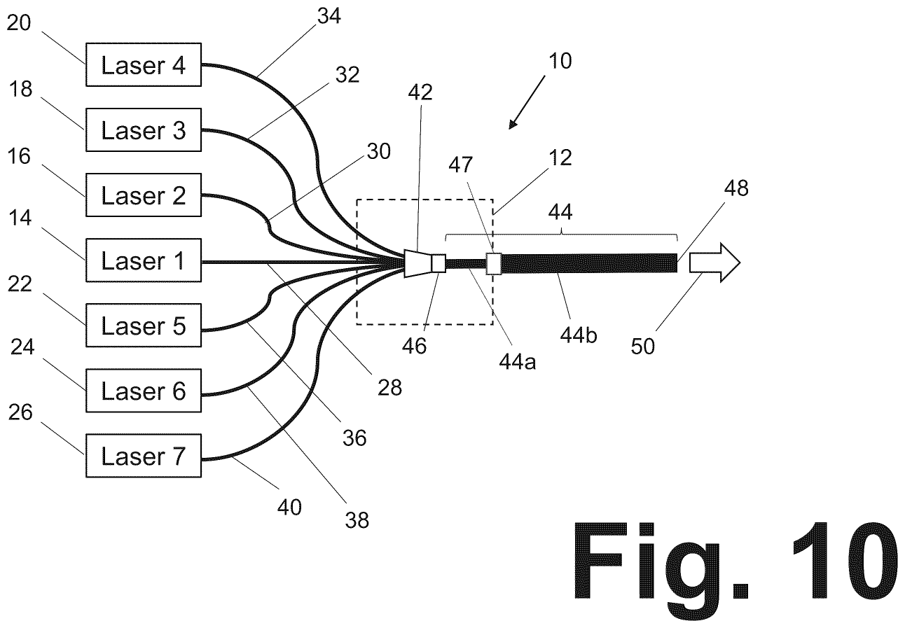

Still further, while the output fiber 44 is illustrated as a single structure, it is contemplated that the output fiber 44 may comprise two or more output fibers and/or output fiber segments that are spliced and/or are fused to one another. This contemplated embodiment is illustrated in FIG. 10.

In the embodiment shown in FIG. 10, the output fiber 44 has a first output fiber segment 44a that is contained within the optical combiner 12. A second output fiber segment 44b lies outside of the optical combiner 12. The first output fiber segment 44a is fused to the second output fiber segment 44b at a second splice 47. The first output fiber segment 44a and the second output fiber segment 44b collectively form the output fiber 44.

In one non-limiting example, the first output fiber segment 44a may be identical to the second output fiber segment 44b in composition and in cross-section.

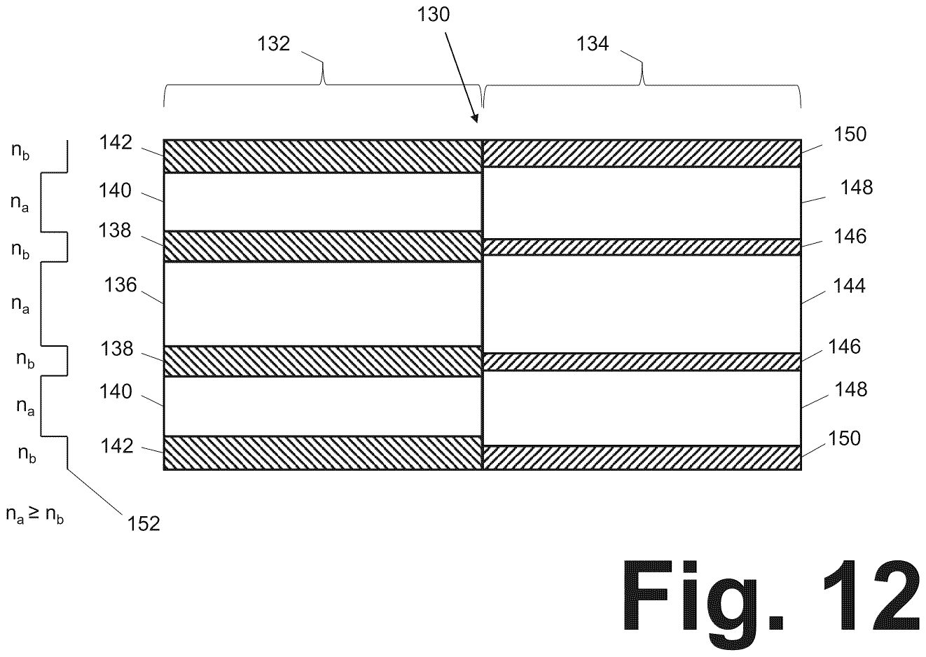

In another non-limiting example, as illustrated in FIG. 12, the second splice 47 may be a multi-core step-up splice 130.

Generally, the design of a multi-core step-up splice, such as the multi-core step-up splice 130 discussed hereinbelow, is such that the first and second fibers ensure that light propagating in the inner core of the first fiber is efficiently coupled into the inner core of the second fiber, and light propagating in the outer core of the first fiber is efficiently coupled into the outer core of the second fiber, taking into account the fiber-manufacturing and splicer-alignment tolerances. Specifically, the dimensions and tolerances of the core and cladding regions are specified to ensure high coupling efficiencies between the inner cores and between the outer cores, with minimal cross talk or loss from either guiding region. Such a design ensures good manufacturability and serviceability (i.e., high yield) when the splice is performed between the first and second fibers in the factory or in the field.

In the multi-core step-up splice 130 illustrated in FIG. 12, a first output fiber segment 132 is connected to a second output fiber segment 134. The multi-core step-up splice 130 permits the two optical fibers 132, 134, both of which are multi-core fibers, to be joined to one another in a manner that manages tolerances and variations between the fiber segments 132, 134. The tolerances encompass, but are not limited, to dimensional tolerances and alignment tolerances associated with the fiber segments 132, 134.

In the non-limiting example depicted in FIG. 12, the first output fiber segment 132 has a first inner core 136 surrounded by a first inner core cladding 138. The first output fiber segment 132 also has a first outer core 140 surrounded by a first outer core cladding 142. Similarly, the second output fiber segment 134 has a second inner core 144 surrounded by a second inner core cladding 146. The second output fiber segment 134 also has a second outer core 148 surrounded by a second outer core cladding 150.

To assure that light passing through the first inner core 136 is transmitted to the second inner core 144, the diameter of the second inner core 144 is slightly larger than the diameter of the first inner core 136. Similarly, to assure that light passing through the first outer core 140 is transmitted to the second outer core 148, the thickness of the second outer core 148 is slightly larger than the thickness of the first outer core 140. So that the first output fiber segment 132 and the second output fiber segment 134 have the same outside diameters, as shown, the thickness of the second inner core cladding 146 is less than the thickness of the first inner core cladding 138. Similarly, the thickness of the second outer core cladding 150 is less than the thickness of the first outer core cladding 142.

FIG. 12 also includes a refractive index profile 152 for the first output fiber segment 132. This profile illustrates that the refractive index nₐ for the first inner core 136 is greater than the refractive index n_{b} of the first inner core cladding 138. Similarly, the refractive index nₐ for the first outer core 140 is greater than the refractive index n_{b} of the first outer core cladding 142. As should be apparent to those skilled in the art, the refractive index profile 152 is merely exemplary. Other profiles may be employed without departing from the scope of the present invention. Moreover, the construction of the multi-core step-up splice 130 may be employed in any location of the present invention where two optic fibers are spliced together, as required and/or as desired. Still further, the refractive index profile 152 is considered to be applicable to any of the optical fibers discussed herein.

Returning to FIG. 2, the first fiber bundle 52 combines the output ends of the input fibers 28, 30, 32, 34, 36, 38, 40, shown in FIG. 1, into a close-packed configuration. Specifically, in the first fiber bundle 52, the input fibers 28, 30, 32, 34, 36, 38, 40 are arranged as a central input fiber 28 surrounded by six flanking input fibers 30, 32, 34, 36, 38, 40. The central fiber 28 also is referred to as a first fiber 28. The six flanking input fibers are referred to as second through seventh fibers 30, 32, 34, 36, 38, 40. This arrangement is often referred to as a “hexagonal close packed arrangement” by those skilled in the art.

While not intended to be limiting of the present invention, the first input fiber 28 is connected to the first laser 14, the second input fiber 30 is connected to the second laser 16, the third input fiber 32 is connected to the third laser 18, the fourth input fiber 34 is connected to the fourth laser 20, the fifth input fiber 36 is connected to the fifth laser 22, the sixth input fiber 38 is connected to the sixth laser 24, and the seventh input fiber 40 is connected to the seventh laser 26.

In FIG. 2, to identify more easily which input fibers 28, 30, 32, 34, 36, 38, 40 connect to which lasers 14, 16, 18, 20, 22, 24, 26, the input fibers 28, 30, 32, 34, 36, 38, 40 are numbered 1-7. The numbers 1-7 correspond to the first through seventh input fibers 28, 30, 32, 34, 36, 38, 40 and the first through seventh lasers 14, 16, 18, 20, 22, 24, 26.

As should be immediately apparent, the association of the first through seventh input fibers 28, 30, 32, 34, 36, 38, 40 with the first through seventh lasers 14, 16, 18, 20, 22, 24, 26 in the manner illustrated in FIGS. 1 and 2 is not intended to be limiting of the present invention. The first through seventh input fibers 28, 30, 32, 34, 36, 38, 40 may be arranged in any order. Moreover, the first through seventh lasers 14, 16, 18, 20, 22, 24, 26, conversely, may be attached to any of the first through seventh input fibers 28, 30, 32, 34, 36, 38, 40 in any suitable order without departing from the scope of the present invention.

As illustrated in FIG. 2, the first through seventh input fibers 28, 30, 32, 34, 36, 38, 40 are contemplated to comprise first through seventh input fiber cores 54, 56, 58, 60, 62, 64, 66 that are surrounded by claddings designated as first through seventh input fiber claddings 68, 70, 72, 74, 76, 78, 80. It is contemplated that the first through seventh input fiber cores 54, 56, 58, 60, 62, 64, 66 have a first refractive index n1 (also referred to as an index of refraction) and that the first through seventh input fiber claddings 68, 70, 72, 74, 76, 78, 80 have a second refractive index n2, less than the first refractive index n1 (n2<n1).

In one contemplated non-limiting embodiment, each of the first through seventh input fiber cores 54, 56, 58, 60, 62, 64, 66 are contemplated to be made from the same material and, therefore, to have the same first refractive index n1. Similarly, the first through seventh input fiber claddings 68, 70, 72, 74, 76, 78, 80 are contemplated to be made from the same material and have the same second refractive index n2.

It is noted that any of the first through seventh input fiber cores 54, 56, 58, 60, 62, 64, 66 may be made from different materials and, therefore, may have different refractive indices from one another. Similarly, any of the first through seventh input fiber claddings 68, 70, 72, 74, 76, 78, 80 may be made from different materials such that they have different refractive indices from one another.

In the embodiment illustrated in FIG. 2, it is contemplated that the first through seventh input fibers 28, 30, 32, 34, 36, 38, 40 have the same diameters. Additionally, it is contemplated that the first through seventh input fiber cores 54, 56, 58, 60, 62, 64, 66 have the same diameters. Accordingly, it is also contemplated that the first through seventh input fiber claddings 68, 70, 72, 74, 76, 78, 80 have the same thicknesses.

It is noted, however, that the diameters of the first through seventh input fibers 28, 30, 32, 34, 36, 38, 40, the diameters of the first through seventh input fiber cores 54, 56, 58, 60, 62, 64, 66, and the diameters/thicknesses of the first through seventh input fiber claddings 68, 70, 72, 74, 76, 78, 80 may be changed without departing from the scope of the present invention. Moreover, the diameters of the first through seventh input fibers 28, 30, 32, 34, 36, 38, 40, the diameters of the first through seventh input fiber cores 54, 56, 58, 60, 62, 64, 66, and the diameters/thicknesses of the first through seventh input fiber claddings 68, 70, 72, 74, 76, 78, 80 may differ from one another without departing from the scope of the present invention.

Without limiting the present invention, it is separately contemplated, for example, that the diameter/thickness of the first input fiber cladding 68 may be greater than the diameters/thicknesses of the second through seventh input fiber claddings 70, 72, 74, 76, 78, 80. This may offer advantages as should be apparent to those skilled in the art.

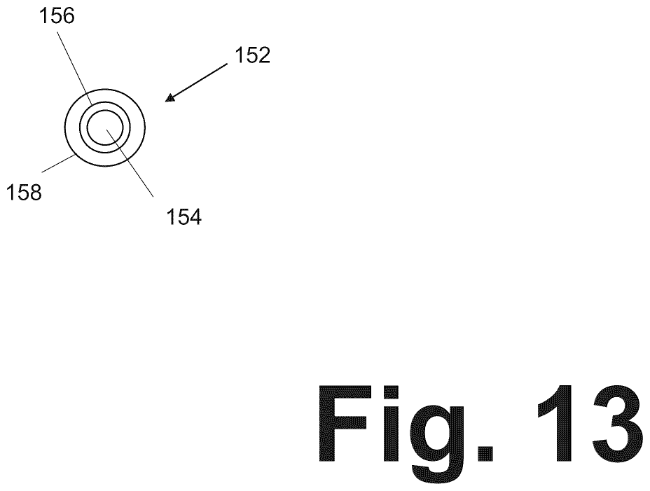

In addition, it is noted that any one of the first through seventh input fibers 28, 30, 32, 34, 36, 38, 40 and/or the output fiber 44 may have multiple claddings (e.g., two or more claddings) without departing from the scope of the present invention. A multiclad fiber 152 is illustrated in FIG. 13 as an example of this contemplated construction. Here, the multiclad core 154 is surrounded by a first cladding 156. The first cladding 156 is, in turn, surrounded by a second cladding 158. Additional cladding also may be employed without departing from the scope of the present invention.

With continued reference to FIG. 2, the first through seventh input fibers 28, 30, 32, 34, 36, 38, 40 are surrounded by a first optional glass support structure 82, which may be structured as a capillary or tube disposed around the first through seventh input fibers 28, 30, 32, 34, 36, 38, 40. It is contemplated that the first glass support structure 82 will provide structure and support for the first through seventh input fibers 28, 30, 32, 34, 36, 38, 40 disposed therein.

Being optional, the first glass support structure 82 may be omitted without departing from the present invention.

With continued reference to FIG. 2, a first interstitial space 84 is established in a cylindrical channel 83 between the first glass support structure 82 and the first through seventh input fibers 28, 30, 32, 34, 36, 38, 40. The first interstitial space 84, in this embodiment, is a cylindrically-shaped space (circular in cross-section). It is contemplated that the first interstitial space 84 in the cylindrical channel 83 is filled with air. However, the first interstitial space 84 may be filled with any other material without departing from the scope of the present invention.

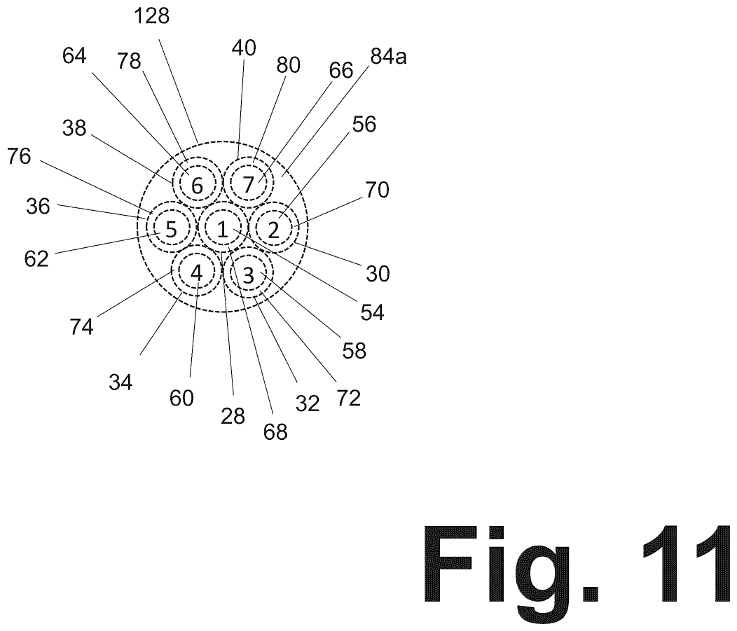

Another non-limiting example of a fifth fiber bundle 128 is illustrated in FIG. 11. This fifth fiber bundle 128 is contemplated to be similar to the first fiber bundle 52 in that the first through seventh input fibers 28, 30, 32, 34, 36, 38, 40 are arranged in a close packed hexagonal configuration.

In the fifth fiber bundle 128, there is(are) no interstitial space(s) 84 between the first through seventh input fibers 28, 30, 32, 34, 36, 38, 40. Here, the first through seventh input fibers 28, 30, 32, 34, 36, 38, 40 are disposed within a glass and/or fused silica carrier 84a. In a variation of this fifth fiber bundle 128, the first through seventh input fibers 28, 30, 32, 34, 36, 38, 40 may be fused to one another, thereby also avoiding a construction with any interstitial space 84.

As should be apparent to those skilled in the art, still other configurations of the fifth fiber bundle 128 are possible without departing from the scope of the present invention.

Returning to FIG. 2, the output fiber 44 is depicted on the right side of the illustration.

The output fiber 44 is a multi-core output fiber 44 that includes an inner core 86 surrounded by an outer core 88. The inner core 86 is surrounded by an inner core cladding 90. Similarly, the outer core 88 is surrounded by an outer core cladding 92. The outer core cladding is surrounded by an (optional) output fiber glass support structure 94 akin to the first glass support structure 82 discussed above.

In a non-limiting example, it is contemplated that the inner core 86 and the outer core 88 will be made from the same material such that the inner core 86 and the outer core 88 have the same refractive index. Here, to distinguish the refractive index of the inner core 86 and the outer core 88 from the first and second refractive indices n1, n2 discussed in connection with the first fiber bundle 52, the refractive index for the inner core 86 and for the outer core 88 is referred to as the third refractive index n3.

This construction for the output fiber 44 is not intended to be limiting of the present invention. The inner core 86 may be made from a different material than the outer core 88 such that they do not share the same third refractive index n3.

In this same non-limiting example, it is contemplated that the inner core cladding 90 and the outer core cladding 92 will be made from the same material such that the inner core cladding 90 and the outer core cladding 92 have the same refractive index. Here, to distinguish the refractive index of the inner core cladding 90 and the outer core cladding 92 the first, second, and third refractive indices n1, n2, n3 discussed above, the refractive index for the inner core cladding 90 and for the outer core cladding 92 is referred to as the fourth refractive index n4. As should be apparent to those skilled in the art, the fourth refractive index n4 is contemplated to be less than the third refractive index n3 (n4<n3).

In an alternative construction, the inner core cladding 90 may be made from a different material than the outer core cladding 92 such that they do not share the same fourth refractive index n4.

As illustrated in FIG. 2, the first fiber bundle 52 is constructed with a first fiber bundle diameter 96. The output fiber 44 is constructed to have an output fiber diameter 98. In the illustrated embodiment, the first fiber bundle diameter 96 is the same as the output fiber diameter 98. This construction is not intended to limit the present invention, however. The first fiber bundle diameter 96 may be less than the output fiber diameter 98. Alternatively, it is contemplated that the output fiber diameter 98 may be less than the first fiber bundle diameter 96.

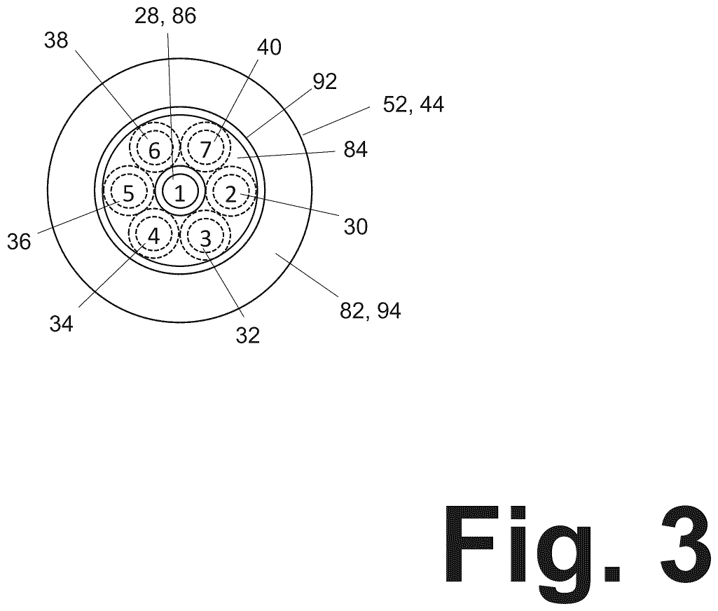

FIG. 3 is a combined, graphical, cross-sectional view of the first embodiment of the input fiber bundle 52 and the output fiber 44, shown in FIG. 2.

When spliced together at the first splice 46, it is contemplated that the first input fiber 28 in the input fiber bundle 52 will be in register with the inner core 86 of the output fiber 44. And, as shown, it is contemplated that the second through seventh input fibers 30, 32, 34, 36, 48, 40 will be in register with the outer core 88 of the output fiber 44.

In a further non-limiting embodiment, multiple input fibers may be in register with the inner core 86 without departing from the scope of the present invention.

When the first fiber bundle 52 and the output fiber 44 are spliced together in the manner illustrated in FIG. 3, the light from the first laser 14 passes through the first input fiber 28 and is guided or coupled into the inner core 86 of the output fiber 44. Similarly, light from one or more of the second through seventh lasers 16, 18, 20, 22, 24, 26 passes through corresponding ones of the second through seventh input fibers 30, 32, 34, 36, 38, 40 and is guided or coupled into the outer core 88. The light passing through the inner core 86 and the outer core 88 exits from the output fiber 44 as the output light 50.

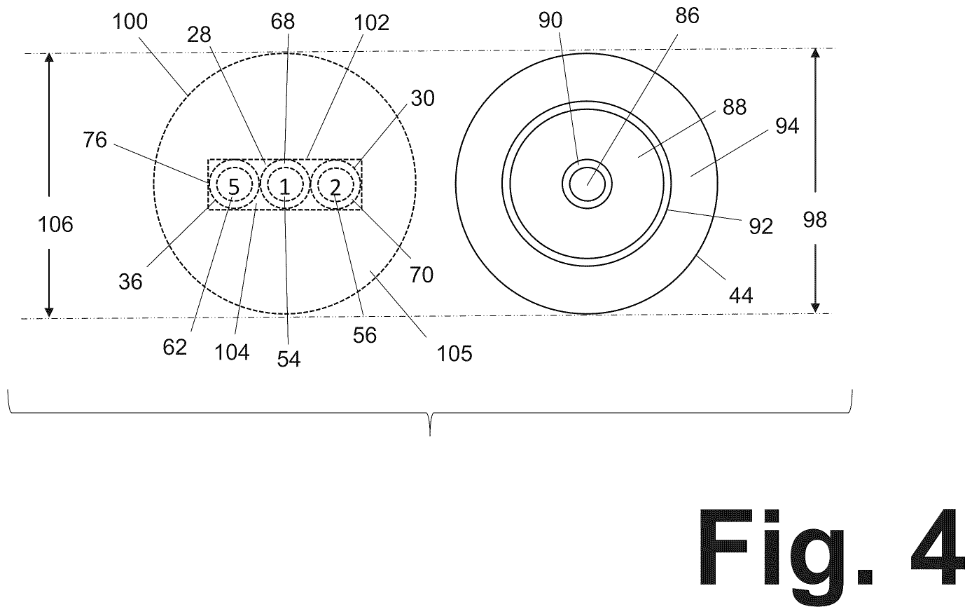

FIG. 4 presents a graphical, cross-sectional view of a second embodiment of an input bundle 100 together with the graphical, cross-sectional view of the output fiber 44. As with the embodiment illustrated in FIGS. 2 and 3, the second fiber bundle 100 and the output fiber 44 are contemplated to be coupled to one another in the optical combiner 12 of the present invention.

As is apparent from this illustration, the second fiber bundle 100 differs in its construction from the first fiber bundle 52 in several respects.

In this second embodiment, the second fiber bundle 100 includes only three input fibers, the first input fiber 28, the second input fiber 30, and the fifth input fiber 36. As should be apparent, these three particular input fibers are illustrated here, because they comport with the positional orientations of the first through seventh input fibers 28, 30, 32, 34, 36, 38 40 in the first fiber bundle 52. However, the present invention is not limited to this selection. Any three of the first through seventh input fibers 28, 30, 32, 34, 36, 38, 40 may be employed as the three input fibers in the second fiber bundle 100 without departing from the scope of the present invention.

In this second fiber bundle 100, the input fibers 28, 30, 36 are arranged in a linear fashion within the second fiber bundle 100. As such, the input fibers 28, 30, 36 are disposed in a rectangularly shaped channel 102 that defines a rectangularly shaped, second interstitial space 104 within the second fiber bundle 100. Here, the second glass support structure 106 is constructed to define the rectangularly shaped channel 102 and the second interstitial space 104. It is noted that the channel 102 may have any other shape, other than rectangular, without departing from the scope of the present invention. For example, the channel 102 may be oval, elliptical, etc.

As illustrated in FIG. 4, the output fiber 44 is constructed in the same manner as previously described.

In this second embodiment, the second fiber bundle 100 has a second fiber bundle diameter 106. The second diameter fiber bundle diameter 106 is the same as the output fiber diameter 98 of the output fiber 44.

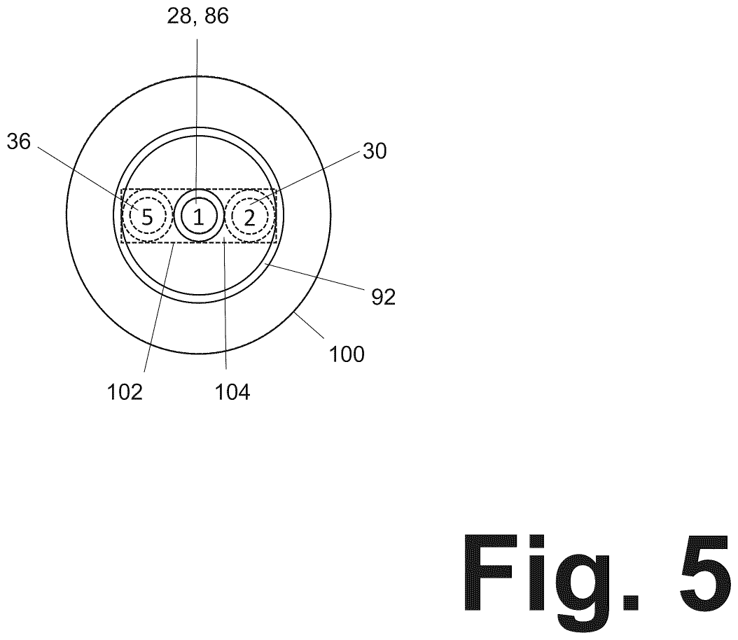

FIG. 5 is a combined, graphical, cross-sectional view of the second embodiment of the second input fiber bundle 100 and the output fiber 44.

As illustrated, the second input fiber bundle 100 is spliced onto the output fiber 44 so that the first input fiber 28 is in register with the inner core 86 of the output fiber 44. In this second embodiment, the second input fiber 30 and the fifth input fiber 36 are in register with the outer core 88. As a result, the light from the first laser 14 passes through the first input fiber 28 and is guided or coupled into the inner core 86 of the output fiber 44. Light from the second input fiber 30 and from the fifth input fiber 36 is guided or coupled into the outer core 88. As in the first embodiment, the light passing through the inner core 86 and the outer core 88 exits from the output fiber 44 as the output light 50.

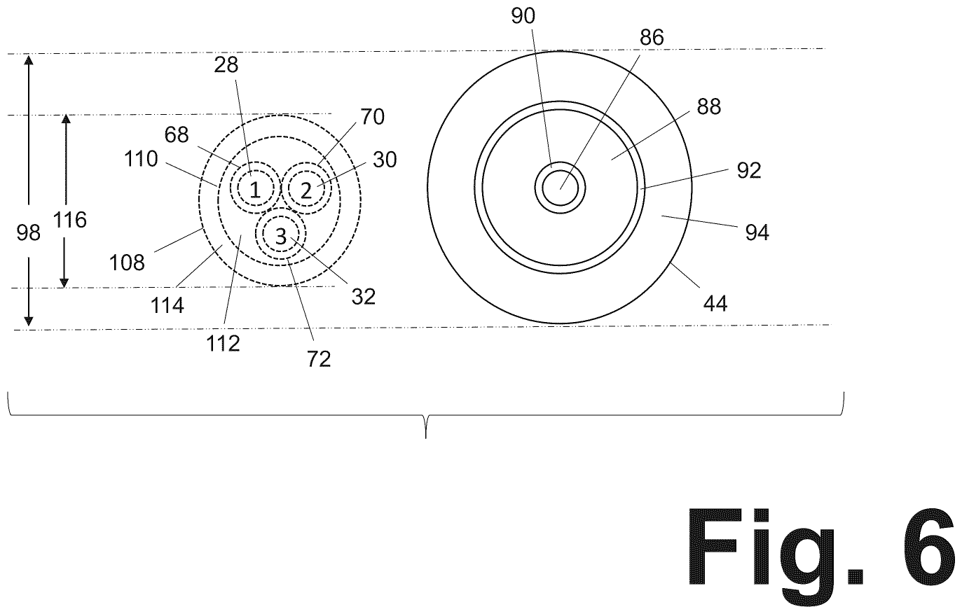

FIG. 6 presents a graphical, cross-sectional view of a third embodiment of a third fiber bundle 108 and a graphical, cross-sectional view of the output fiber 44. As with the first and second embodiments, discussed above, the third fiber bundle 108 and the output fiber 44 are contemplated to be coupled to one another in the optical combiner 12 of the present invention.

The third fiber bundle 108 differs in its construction from the first fiber bundle 52 and the second fiber bundle 100 in several respects.

In this third embodiment, the third fiber bundle 108 includes only three input fibers, the first input fiber 28, the second input fiber 30, and the third input fiber 32. As in the discussion of the second fiber bundle 100, the first input fiber 28, the second input fiber 30, and the third input fiber 32 have been selected, because their respective positional orientations are consistent with the orientations of the first input fiber 28, the second input fiber 30, and the third input fiber 32 illustrated in connection with the first fiber bundle 52.

As discussed in connection with the second fiber bundle 100, the present invention should not be understood to be limited solely to reliance on the first input fiber 28, the second input fiber 30, and the third input fiber 32. Any of the first through seventh input fibers 28, 30, 32, 34, 36, 38, 40 may be employed without departing from the scope of the present invention.

In this third fiber bundle 108, the input fibers 28, 30, 32 are disposed in a close-packed configuration where the three input fibers 28, 20, 32 are arranged in a triangular pattern. The three input fibers 28, 30, 32 are combined in a twisted bundle, which causes the three input fibers 28, 30, 32 to be helically wrapped together. The three input fibers 28, 30, 32 are disposed in a cylindrically shaped channel 110, similar to the cylindrical channel provided in the first fiber bundle 52. The cylindrically shaped channel 110 defines a third interstitial space 112 therewithin.

Unlike the first fiber bundle 52, because it contains only three input fibers 28, 30, 32, the cylindrically shaped channel 110 has a smaller diameter and, therefore, the third glass support structure 114 presents a third fiber bundle diameter 116 that is smaller than either the first fiber bundle diameter 96 or the second fiber bundle diameter 106. As shown, the third fiber bundle diameter 116 also is smaller than the output fiber diameter 98. This illustrated configuration, however, should not be understood to be limiting of the present invention. The third glass support structure 114 may be sized so that the third fiber bundle diameter 116 is equal to or larger than the output fiber diameter 98.

As illustrated in FIG. 6, the output fiber 44 is constructed in the same manner as previously described.

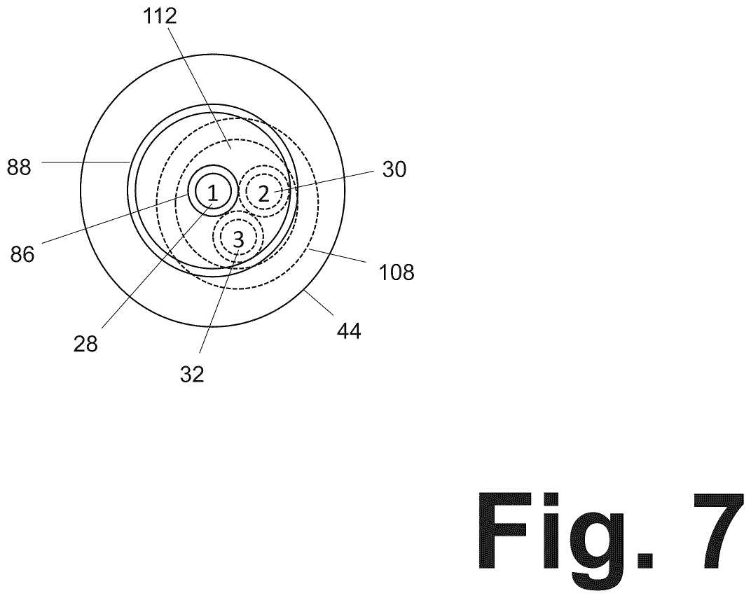

FIG. 7 is a combined, graphical, cross-sectional view of the second embodiment of the third input fiber bundle 108 and the output fiber 44.

Here, because the first input fiber 28 is not in the center of the third input fiber bundle 108, and because the input fibers 28, 30, 32 are not arranged linearly, the center of the third fiber bundle 108 is offset from the center of the output fiber 44 when they are spliced together. However, as before, the first input fiber 28 is in register with the inner core 86 of the output fiber 44. In this third embodiment, the second input fiber 30 and the third input fiber 32 are in register with the outer core 88. As a result, the light from the first laser 14 passes through the first input fiber 28 and is guided or coupled into the inner core 86 of the output fiber 44. Light from the second input fiber 30 and from the third input fiber 32 is guided or coupled into the outer core 88.

As in the first and second embodiments, the light passing through the inner core 86 and the outer core 88 exits from the output fiber 44 as the output light 50.

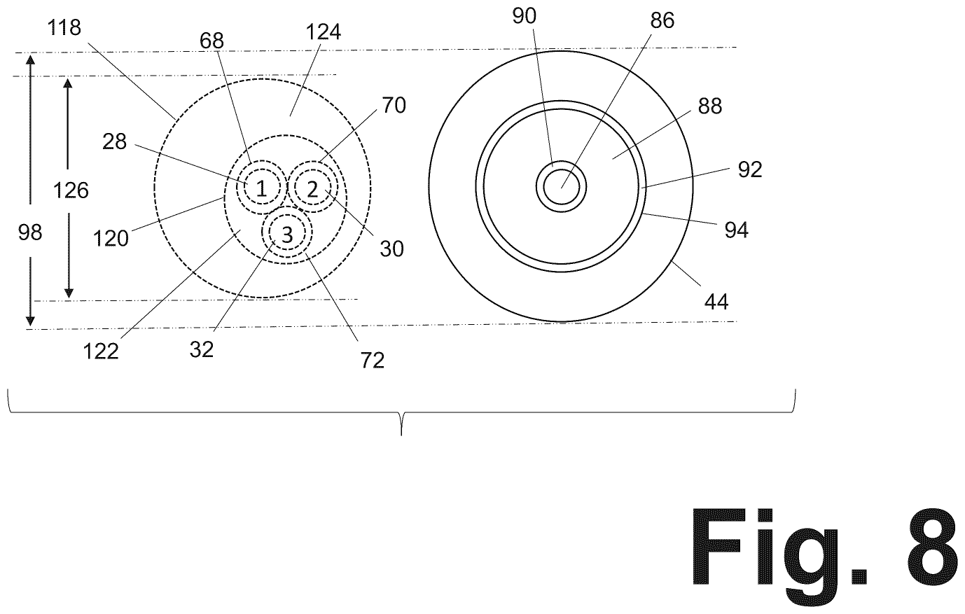

FIG. 8 presents a graphical, cross-sectional view of a fourth fiber bundle 118 and a graphical, cross-sectional view of the output fiber 44. As before, the fourth fiber bundle 118 and the output fiber 44 are contemplated to be coupled to one another in the optical combiner 12 of the present invention.

The fourth fiber bundle 118 differs from the first fiber bundle 52, the second fiber bundle 100, and the third fiber bundle 108 in several respects.

While the fourth fiber bundle 118 also relies on the first input fiber 28, the second input fiber 30, and the third input fiber 32 to provide light from the first through third lasers 14, 16, 18 to the output fiber 44, the fourth fiber bundle 118 incorporates an offset cylindrical channel 120 that surrounds the first input fiber 28, the second input fiber 30, and the third input fiber 32. The offset cylindrical channel 120 defines a fourth interstitial space 122 around the first input fiber 28, the second input fiber 30, and the third input fiber 32.

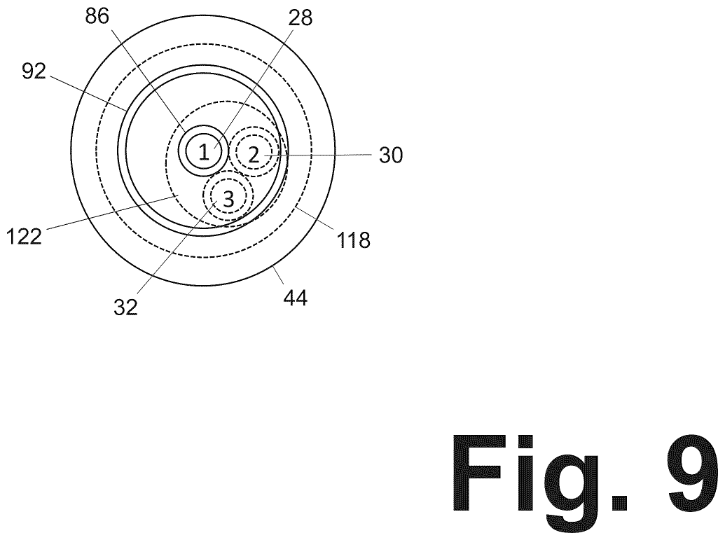

As is apparent from FIGS. 8 and 9, the fourth glass support structure 124 does not have a uniform thickness, because of the offset placement of the offset cylindrical channel 120. In this embodiment, the fourth fiber bundle 118 has a fourth fiber bundle diameter 126 is less than the output fiber diameter 98 but larger than the third fiber bundle diameter 116. As with other embodiments, the illustrated configuration should not be understood to be limiting of the present invention. The fourth glass support structure 124 may be sized so that the fourth fiber bundle diameter 126 is equal to or larger than the output fiber diameter 98.

FIG. 9 is a combined, graphical, cross-sectional view of the fourth input fiber bundle 118 and the output fiber 44.

As with the third fiber bundle 108, the manner in which the fourth fiber bundle 118 is spliced to the output fiber 44 is a little more complex than the first embodiment or the second embodiment. Nevertheless, as before, the first input fiber 28 is in register with the inner core 86 of the output fiber 44. In this fourth embodiment, the second input fiber 30 and the third input fiber 32 are in register with the outer core 88. As a result, the light from the first laser 14 passes through the first input fiber 28 and is guided or coupled into the inner core 86 of the output fiber 44. Light from the second input fiber 30 and from the third input fiber 32 is guided or coupled into the outer core 88.

As in the first, second, and third embodiments, the light passing through the inner core 86 and the outer core 88 exits from the output fiber 44 as the output light 50.

As discussed hereinabove, the embodiments of the present invention are exemplary only and are not intended to limit the present invention. Features from one embodiment are interchangeable with other embodiments, as should be apparent to those skilled in the art. As such, variations and equivalents of the embodiments described herein are intended to fall within the scope of the claims appended hereto.

What is claimed is:

1. An optical combiner, comprising:
a fiber bundle comprising a plurality of input fibers;
an output fiber comprising an inner core surrounded by an outer core;
a splice fusing the fiber bundle to the output fiber;
at least a first input fiber from the plurality of input fibers being aligned in register with the inner core; and
at least a second input fiber from the plurality of input fibers being aligned in register with the outer core.

2. The optical combiner according to claim 1, wherein at least one of the plurality of input fibers comprises multiple claddings.

3. The optical combiner according to claim 1, wherein the output fiber comprises multiple claddings.

4. The optical combiner according to claim 1, wherein the plurality of input fibers comprises:
the first input fiber, the second input fiber, a third input fiber, a fourth input fiber, a fifth input fiber, a sixth input fiber, and a seventh input fiber.

5. The optical combiner according to claim 4, wherein:
the first input fiber is surrounded by the second input fiber, the third input fiber, the fourth input fiber, the fifth input fiber, the sixth input fiber, and the seventh input fiber.

6. The optical combiner according to claim 5, wherein:
the third input fiber, the fourth input fiber, the fifth input fiber, the sixth input fiber, and the seventh input fiber also are aligned in register with the outer core.

7. The optical combiner according to claim 1, wherein the plurality of input fibers comprises:
the first input fiber, the second input fiber, and a third input fiber.

8. The optical combiner according to claim 7, wherein:
the first input fiber is disposed adjacent to the second input fiber and the third input fiber in a linear configuration.

9. The optical combiner according to claim 8, wherein:
the second input fiber and the third input fiber are aligned in register with the outer core.

10. The optical combiner according to claim 7, wherein:
the first input fiber is disposed adjacent to the second input fiber and the third input fiber in a triangular configuration.

11. The optical combiner according to claim 10, wherein:
the third input fiber also is aligned in register with the outer core.

12. The optical combiner according to claim 1, further comprising:
a glass support structure, wherein the plurality of input fibers is disposed therein.

13. The optical combiner according to claim 1, wherein the output fiber comprises:
a first output fiber segment fused to a second output fiber segment at a second splice.

14. The optical combiner according to claim 13, wherein the second splice is a multi-core step-up splice.

15. A laser system, comprising:
a plurality of lasers generating laser light; and
an optical combiner connected to the plurality of lasers, wherein the optical combiner comprises
a fiber bundle comprising a plurality of input fibers receiving the laser light from the plurality of lasers,
an output fiber comprising an inner core surrounded by an outer core receiving the laser light from the fiber bundle,
a splice fusing the fiber bundle to the output fiber,
at least a first input fiber from the plurality of input fibers being aligned in register with the inner core; and
at least a second input fiber from the plurality of input fibers being aligned in register with the outer core.

16. The laser system according to claim 15, wherein at least one of the plurality of input fibers comprises multiple claddings.

17. The laser system according to claim 15, wherein the output fiber comprises multiple claddings.

18. The laser system according to claim 15, wherein:
the plurality of input fibers comprises the first input fiber, the second input fiber, a third input fiber, a fourth input fiber, a fifth input fiber, a sixth input fiber, and a seventh input fiber,
a first laser from the plurality of lasers provides light to the first input fiber, and
at least a second laser from the plurality of lasers provides light to at least the second input fiber.

19. The laser system according to claim 18, wherein:
the first input fiber is surrounded by the second input fiber, the third input fiber, the fourth input fiber, the fifth input fiber, the sixth input fiber, and the seventh input fiber.

20. The laser system according to claim 19, wherein:
the third input fiber, the fourth input fiber, the fifth input fiber, the sixth input fiber, and the seventh input fiber also are aligned in register with the outer core.

21. The laser system according to claim 15, wherein:
the plurality of input fibers comprises the first input fiber, the second input fiber, and a third input fiber,
a first laser from the plurality of lasers provides light to the first input fiber, and
at least a second laser from the plurality of lasers provides light to at least the second input fiber.

22. The laser system according to claim 21, wherein:
the first input fiber is disposed adjacent to the second input fiber and the third input fiber in a linear configuration.

23. The laser system according to claim 22, wherein:
the third input fiber also is aligned in register with the outer core.

24. The laser system according to claim 21, wherein:
the first input fiber is disposed adjacent to the second input fiber and the third input fiber in a triangular configuration.

25. The laser system according to claim 24, wherein:
the third input fiber also is aligned in register with the outer core.

26. The laser system according to claim 15, further comprising:
a glass support structure, wherein the plurality of input fibers is disposed therein.

27. The laser system according to claim 15, wherein the output fiber comprises:
a first output fiber segment fused to a second output fiber segment at a second splice.

28. The laser system according to claim 27, wherein the second splice is a multi-core step-up splice.
